(19) United States
(12) Patent Application Publication
(10) Pub. No.: US 2012/0053949 A1
(43) Pub. Date: Mar. 1, 2012

(54) ENCODING DEVICE, DECODING DEVICE, ENCODING METHOD, DECODING METHOD AND PROGRAM THEREFOR

(75) Inventors: Shigeaki Sasaki, Tokyo (JP); Kimitaka Tsutsumi, Tokyo (JP); Masahiro Fukui, Tokyo (JP); Yusuke Hiwasaki, Tokyo (JP)

(73) Assignee: NIPPON TELEGRAPH AND TELEPHONE CORP., Chiyoda-ku (JP)

(21) Appl. No.: 13/318,446

(22) PCT Filed: May 28, 2010
(86) PCT No.: PCT/JP10/59093

§ 371 Date: Nov. 1, 2011

(30) Foreign Application Priority Data
May 29, 2009 (JP) 2009-130697

(51) Int. Cl. G10L 19/00

(52) U.S. Cl. 704/500; 704/E19.001

(57) ABSTRACT

There is provided a coding technique capable of reducing the amount of computation in coding while maintaining the efficiency of the coding. The technique uses an input signal and one of a decoded signal decoded from a first code obtained by encoding the input signal and a decoded signal obtained during generation of the first code. A gain group set includes one or more gain groups including different numbers of values corresponding to gains. A gain group is allocated to each sample by using a predetermined method. The sample is multiplied by a gain identified by a value corresponding to each gain in the allocated gain group and a gain code indicating a gain that results in the smallest difference between the product and the input signal is output.

### TECHNICAL FIELD

The present invention relates to a encoding device and a encoding method that encode audio signals such as music and speech signals, a decoding device and a decoding method that decode encoded signals, and a program therefor.

### BACKGROUND ART

There exists a technique in which a transform such as DFT (Discrete Fourier Transform), DCT (Discrete Cosine Transform) or MDCT (Modified Discrete Cosine Transform) is used to transform a sequence of an input signal to a coefficient in frequency domain, the input coefficient is encoded by vector quantization, the resulting code is decoded, and a difference signal between the decoded coefficient and the input coefficient is quantized by vector quantization to accomplish hierarchical encoding (scalable encoding). FIG. 1 illustrates an exemplary configuration of an encoder 20 according to an existing technique, FIG. 2 illustrates an exemplary configuration of a decoder 30 for high quality, and FIG. 3 illustrates an exemplary configuration of a decoder 40 for low quality. A first-layer encoding part 21 of the encoder 20 in FIG. 1 encodes an input signal xm to output a first-layer code C1. The first-layer code C1 is decoded by a first-layer decoding part 23 in the encoder 20 to obtain a first-layer decoded signal ym. A second-layer encoding part 27 encodes a difference signal d′m between the input signal xm and the first-layer decoded signal ym to output a second-layer code C′2. The first-layer code C1 and the second-layer code C′2 are multiplexed by a multiplexing part 29 to obtain a scalable output code C′. In the decoder 30, a demultiplexing part 39 separates the input code C′ to provide first- and second-layer codes C1 and C′2. The first-layer code C1 is decoded by a first-layer decoding part 31 to obtain a first-layer decoded signal ym. The second-layer code C′2 is decoded by a second-layer decoding part 37 to obtain a second-layer decoded signal d′m. An adder 35 adds ym and d′m together to obtain an output signal x′m. The scalable coding can extract a portion of a code and decode the portion of the code to obtain a decoded signal with a quality that is dependent on the number of bits of the code. For example, as illustrated in FIG. 3, the demultiplexing part 39 can extract only the first-layer code C1 from the code C′ output from the encoder 20 and the first-layer decoding part 31 can decode the first-layer code C1 into ym to output it as an output signal x′m (=ym). However, the output signal ym is of a lower quality than the signal resulting from addition of the second-layer decoded signal d′m obtained from the second-layer code C′2. A technique described in Patent literature 1 is an example of the known existing technique.

### PRIOR ART LITERATURE

### Patent Literature

Patent literature 1: Japanese Registered Patent No. 3139602 (Japanese Patent Application Laid-Open No. 8-263096)

### SUMMARY OF THE INVENTION

### Problem to be Solved by the Invention

The use of vector quantization in scalable coding increases the amount of computation layer by layer. While the existing technique generally can achieve a high data compression ratio, the existing technique has the drawback of requiring a huge amount of computation because vector quantization is performed a number of times.

### Means to Solve the Problem

To solve the problem, a encoding technique according to the present invention uses an input signal and a signal decoded from a first code obtained by encoding the input signal or a decoded signal obtained during generation of the first code. A gain group set includes one or more gain groups, each of which includes values corresponding to gains. The numbers of the values vary from one gain group to another. The encoding technique allocates a gain group to each sample of a decoded signal by using a predetermined method, multiplies the sample by a gain identified by a value corresponding to each gain in the allocated gain group, and outputs a gain code indicating a gain that results in the smallest difference between the input signal and the sample multiplied by the gain.

A decoding technique according to the present invention uses a signal decoded from a first code using a decoding scheme appropriate for the first code and a gain code. The gain code is decoded to obtain a gain and the decoded signal is multiplied by the gain. To obtain the gain, a gain group is allocated to each sample of the decoded signal by using a predetermined method and the gain corresponding to the gain code is extracted from the allocated group and is output.

### EFFECTS OF THE INVENTION

The present invention has the effects of reducing the amount of computation in coding while maintaining a high coding efficiency, by allocating one of gain groups including different numbers of gains to each sample of a decoded signal and performing scalar quantization according to the number of gains in the gain group.

### BRIEF DESCRIPTION OF THE DRAWINGS

FIG. 1 is a diagram illustrating an exemplary configuration of an encoder 20;

FIG. 2 is a diagram illustrating an exemplary configuration of a decoder 30;

FIG. 3 is a diagram illustrating an exemplary configuration of a decoder 40;

FIG. 4 is a diagram illustrating an exemplary configuration of a encoding device 100;

FIG. 5 is a flowchart illustrating an exemplary process flow in the encoding device 100;

FIG. 6A is a diagram illustrating an example of data of an output code C output from the encoding device 100; FIG. 6B is a diagram illustrating an example of data of an output code C output from the encoding device 300;

FIG. 7 is a diagram illustrating an exemplary configuration of a second-layer encoding part 110;

FIG. 8 is a flowchart illustrating an exemplary process flow in the second-layer encoding part 110;

FIG. 9 is a diagram for explaining a process performed in and data processed in the second-layer encoding part 110;

FIG. 10 is a diagram illustrating an exemplary configuration of a difference signal calculating part 115;

FIG. 11 is a diagram illustrating an exemplary configuration of a decoding device 200;

FIG. 12 is a flowchart illustrating an exemplary process flow in the decoding device 200;

FIG. 13 is a diagram illustrating an exemplary configuration of the second-layer decoding part 210;

FIG. 14 is a flowchart illustrating an exemplary process flow in the second-layer decoding part 210;

FIG. 15 is a diagram illustrating an exemplary configuration of a encoding device 300;

FIG. 16 is a diagram illustrating an exemplary configuration of a second-layer encoding part 310;

FIG. 17 is a diagram illustrating an exemplary configuration of a second-layer decoding part 410;

FIG. 18 is a diagram illustrating an exemplary configuration of a encoding device 500;

FIG. 19 is a diagram illustrating an exemplary configuration of a decoding device 600;

FIG. 20 is a diagram illustrating an exemplary configuration of a second-layer encoding part 1110 according to a first variation of a first embodiment;

FIG. 21 is a diagram illustrating an example of data of a gain group according to the first variation of the first embodiment; and

FIG. 22 is a flowchart illustrating a process flow in a gain selecting part 1119.

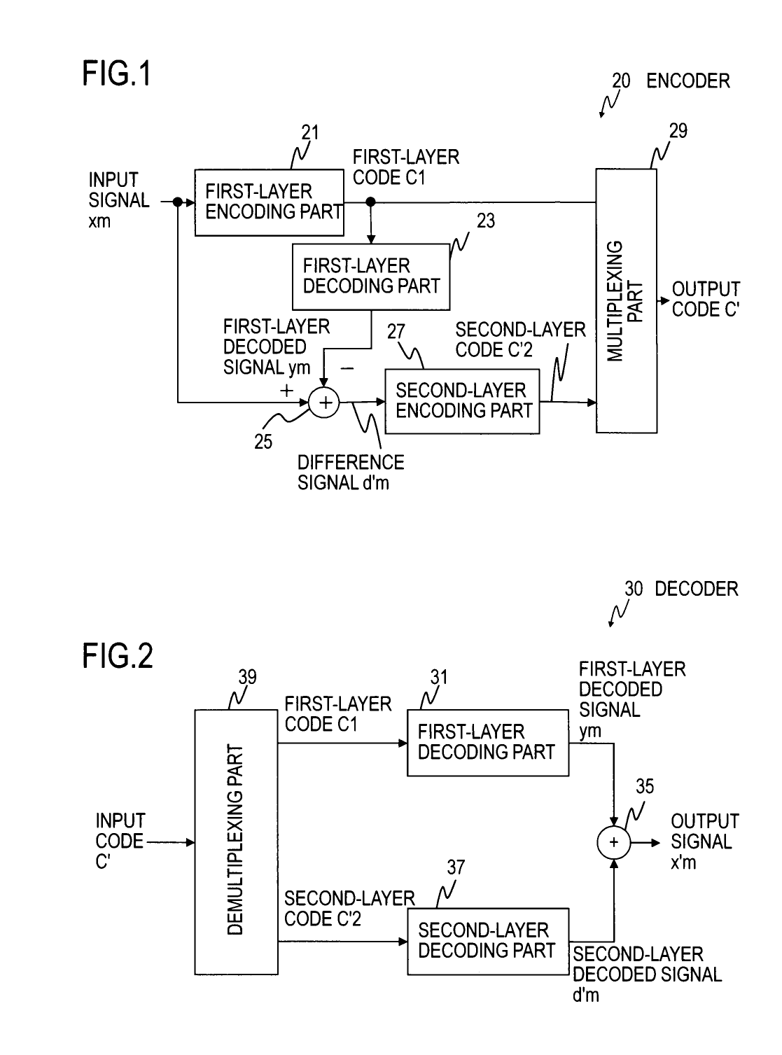

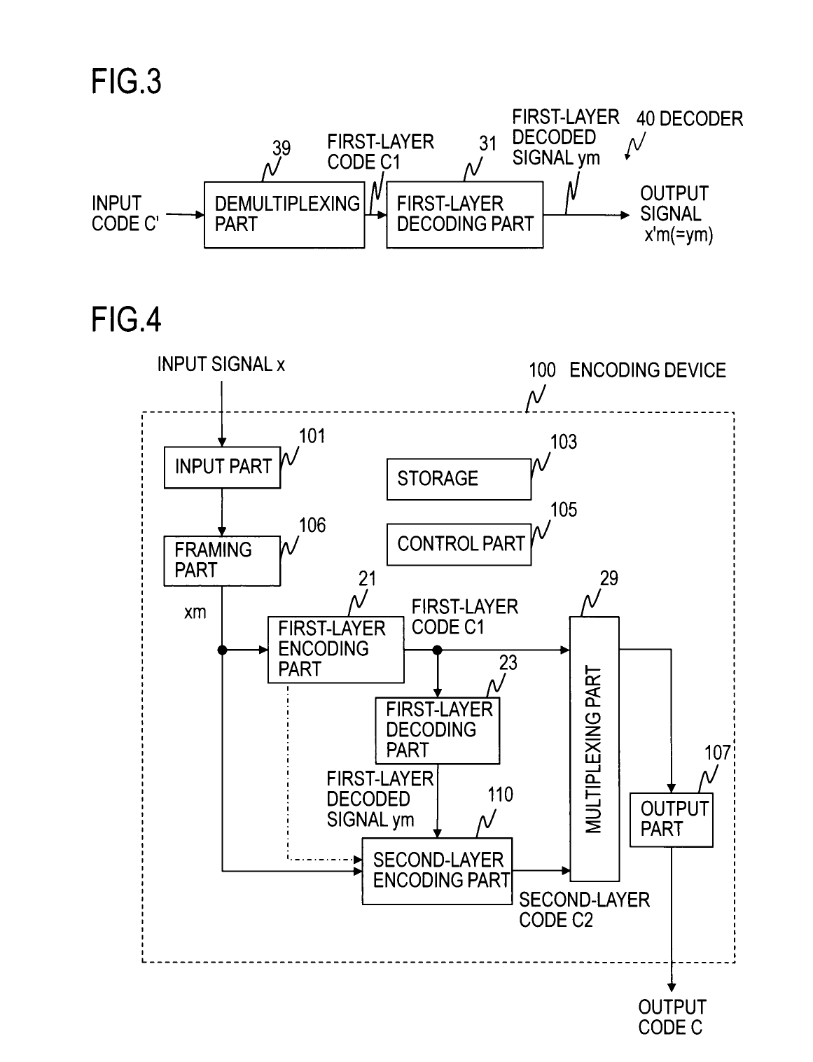

### DETAILED DESCRIPTION OF THE EMBODIMENTS

Embodiments of the present invention will be described below in detail.

### First Embodiment

[Encoding Device 100]

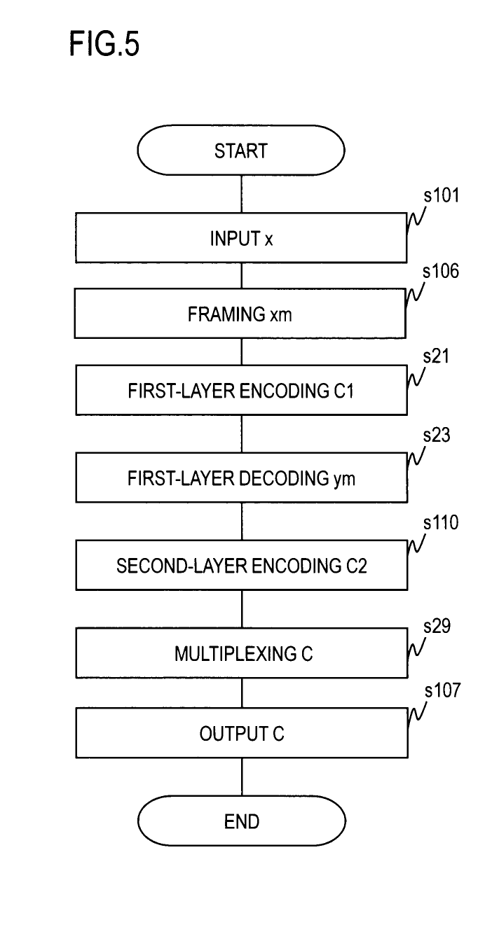

FIG. 4 illustrates an exemplary configuration of a encoding device 100 and FIG. 5 illustrates an exemplary process flow in the encoding device 100. The encoding device 100 includes an input part 101, a storage 103, a control part 105, a framing part 106, a first-layer encoding part 21, a first-layer decoding part 23, a multiplexing part 29, an output part 107, and a second-layer encoding part 110. Processing performed by these components will be described below.

<Input Part 101, Storage 103 and Control Part 105>

The encoding device 100 receives an input signal x through the input part 101 (s101). The input part 101, which may be a microphone and an input interface, for example, converts an input signal such as music and speech signals to an electrical signal. The input part 101 includes a component such as an analog-digital converter, which converts the electrical signal to digital data to output.

The storage 103 stores input and output data and data used during calculation and allows the stored data to be read, as needed, for performing computations. However, data does not necessarily need to be stored in the storage 103; data may be directly transferred among the components.

The control part 105 controls processes.

<Framing Part 106>

The Framing part 106 breaks an input signal x into frames containing a predetermined number of samples (s106). The input signal xm (m is a sample identification number, where m=0, 1, . . . , M−1) is subsequently processed on a frame-by-frame basis in each part. One frame contains M samples and is a unit that is 5 to 20 milliseconds long. The number M of samples in one frame is in the range of 160 to 640 for an audio signal with a sampling rate of 32 kHz, for example. Input signals such as music and speech signals and input signals converted to digital data, and input signals xm in frames are collectively referred to as input signals herein.

<First-Layer Encoding Part 21 and First-Layer Decoding Part 23>

The first-layer encoding part 21 encodes an input signal xm on a frame-by-frame basis by using a first-layer encoding scheme to generate a first-layer code C1 (s21). The first-layer encoding scheme may be CELP encoding, for example.

The first-layer decoding part 23 decodes, for example, the first-layer code C1 by using a first-layer decoding scheme to generate a first-layer decoded signal ym (s23). The first-layer decoding scheme may be CELP decoding, for example. However, if the same value as the first-layer decoded signal ym can be obtained during generation of the first-layer code C1 in the first-layer encoding part 21 or if the first-layer decoded signal ym can be obtained by simpler processing than using the first-layer decoding part 23, the first-layer decoding part 23 does not need to be provided. For example, if CELP encoding is used for encoding in the first-layer encoding part 21, a first-layer decoded signal ym can be obtained in the course of generating the first-layer code C1 and therefore the first-layer decoded signal ym may be output to the second-layer encoding part 110 as indicated by the alternate long and short dashed line in FIG. 4, without providing the first-layer decoding part 23. The present embodiment does not limit the scope of the present invention; other encoding and decoding schemes may be used.

The second-layer encoding part 110 uses the input signal xm and the first-layer decoded signal ym to generate a second-layer code C2 (s110). The second-layer encoding part 110 will be described later in detail.

<Multiplexing Part 29 and Output Part 107>

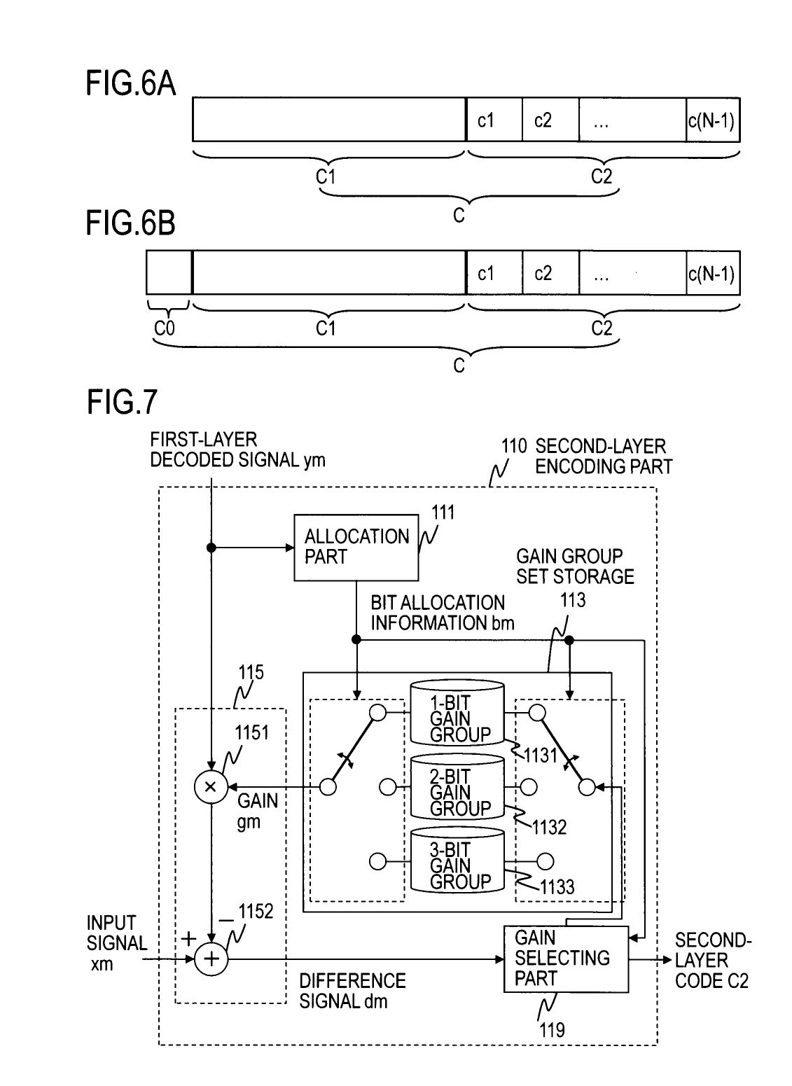

FIG. 6A illustrates an example of data of the output code C for one frame of an input signal. The multiplexing part 29 multiplexes first- and second-layer codes C1 and C2 into an output code C on a frame-by-frame basis (s29).

The output part 107 outputs the output code C. The output part 107 may be a LAN adapter and an output interface, for example (s107).

<Second-Layer Encoding Part 110>

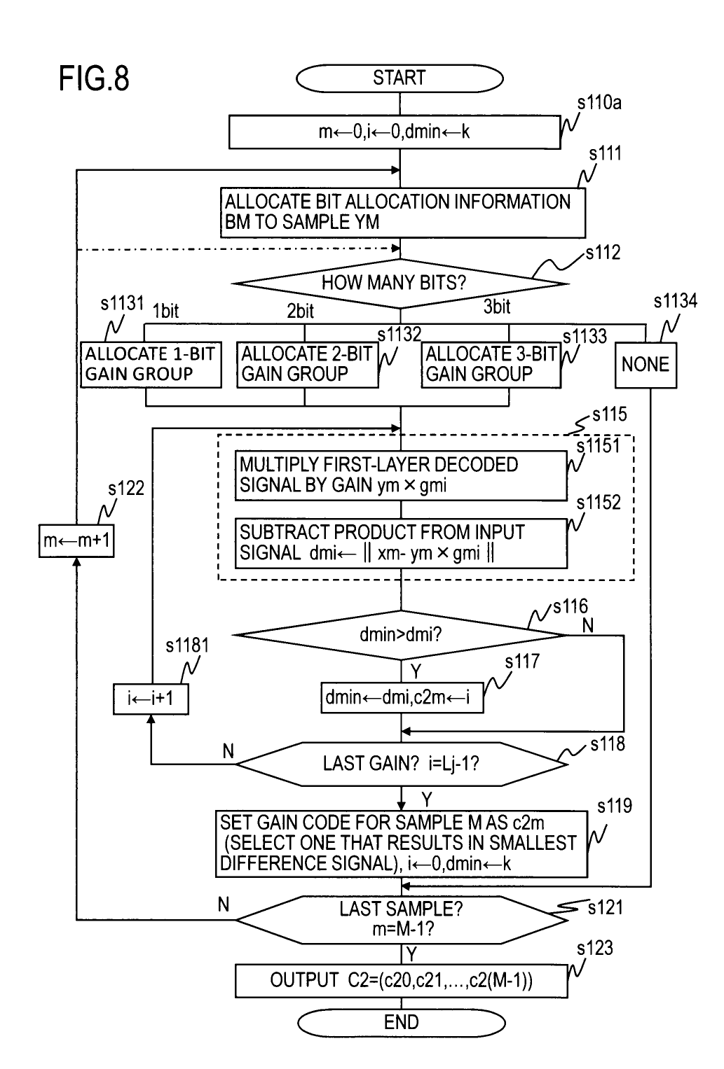

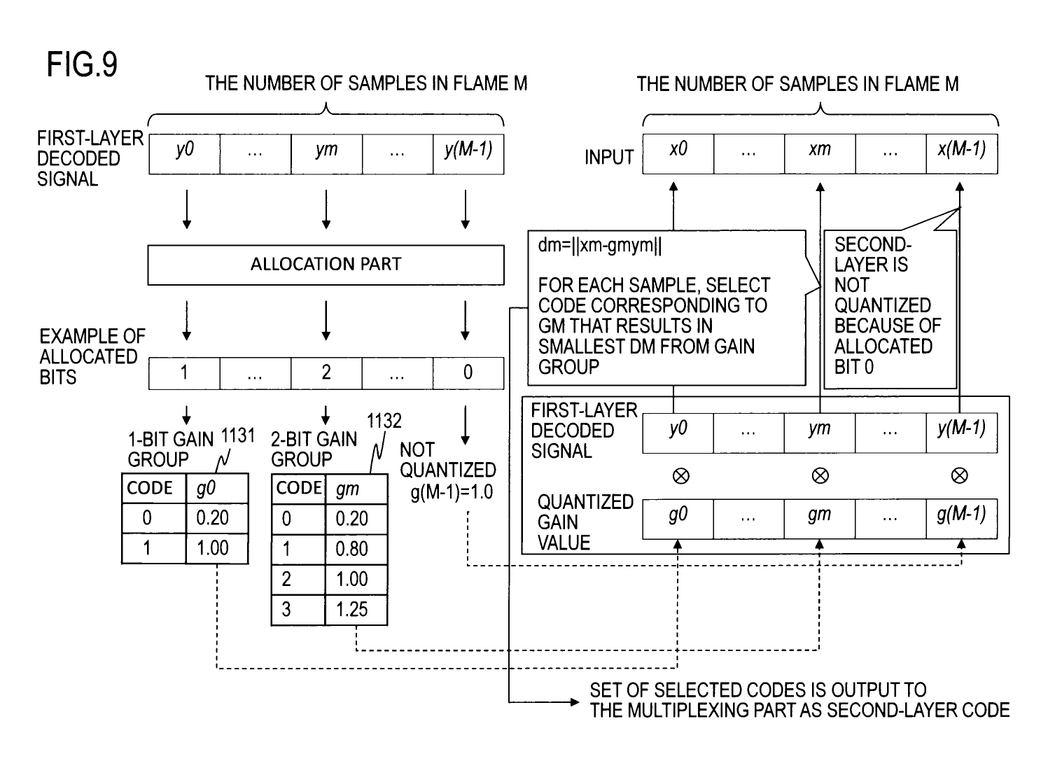

FIG. 7 illustrates an exemplary configuration of the second-layer encoding part 110 and FIG. 8 illustrates an exemplary process flow in the second-layer encoding part 110. FIG. 9 is a diagram for explaining a process performed in and data processed in the second-layer encoding part 110. The second-layer encoding part 110 includes an allocation part 111, a gain group set storage 113, a difference signal calculating part 115, and a gain selecting part 119. Processing performed by these components will be described below.

“Allocation Part 111”

The allocation part 111 allocates a gain group to each sample ym of the first-layer decoded signal (s111). The allocation part 111 allocates gain groups that include more gains to samples that have greater auditory impacts. A gain group set includes J gain groups, which include different numbers of gains, where J≧1. Letting Lj denote the number of gains included in a gain group j (j=1, 2, . . . , J) and gmi denote gain allocated to a sample ym, then i=0, 1, . . . , Lj−1. Whether the auditory impact of a sample is great or not can be determined from the amplitude of the sample or a parameter obtained from the amplitude, or the magnitude of the reciprocal of such a value, for example. For example, one or more threshold values according to the number of gains may be provided and whether or not audible impact is great may be determined on the basis of whether or not the amplitude or any of the values given above is greater than the threshold. Alternatively, a relative magnitude of auditory impact may be determined with respect to the audible impacts of other samples. Alternatively, the magnitude of auditory impact may be determined from the number of digits of a binary number of any of the values given above. Alternatively, whether or not auditory impact is great may be determined after applying a process such as auditory filtering for adding a characteristic that mimics the human auditory sense to the sample ym. Other method may be used to determine whether or not the impact is great. The method for allocation may be reverse water-filling in which bits are allocated to each sample (Reference Literature 1: “G. 729-based embedded variable bit-rate coder: An 8-32 kbit/s scalable wideband coder bitstream interoperable with G. 729”, [online], ITU, [retrieved on May 22, 2009], Internet <URL: http://www.itu.int/rec/T-REC-G.729.1/en>) or a bit allocation algorithm used in lower-band enhancement encoding in ITU-T standard G. 711.1 (Reference Literature 2: “G. 711.1: Wideband embedded extension for G. 711 pulse code modulation”, [online], ITU, [searched on May 22, 2009], Internet <URL: http://www.itu.int/rec/T-REC-G.711.1/en>). The allocation part 111 receives the first-layer decoded signal and outputs allocation information bm. In the present embodiment, the allocation information bm is bit allocation information because bits are allocated to each sample as the allocation information.

If the impact of a sample ym is so small that elimination of information obtained from the amplitude of the sample has not a significant adverse effect on the sound quality or other characteristics of the output signal (that is, the auditory impact of a sample ym is so small that elimination of ym has not a significant adverse effect on the sound quality or other characteristics of the output signal), for example if a value that can be obtained from the amplitude is very small, no gain group may be allocated to the sample ym and gain gm=1 may be set for the sample in a decoding device 200, which will be described later.

“Gain Group Set Storage 113”

The gain group set storage 113 stores a gain group set. The gain group set includes J gain groups, each of which includes Lj gains. The gain group set storage 113 also stores gain codes corresponding to gains.

For example, three gain groups 1131, 1132 and 1133 are stored in the gain group set storage 113 as illustrated in FIG. 7. As illustrated in FIG. 9, a 1-bit gain group contains 2¹=2 gains, a 2-bit gain group contains 2²=4 gains, and a 3-bit gain group contains 2³=8 gains. Exemplary values of gains in the 1-bit gain group 1131 and the 2-bit gain group 1132 and their corresponding exemplary codes are illustrated in FIG. 9. However, the number of gains contained does not need to be proportional to the number of bits. For example, the 3-bit gain group may contain less than 8 gains. The amount of processing can be reduced by reducing the number of gains to be contained, if required. The number of gain groups is not limited to three; a required number J of gain groups are stored in the gain group set storage 113.

A gain group is not limited to the database described above but may be a group that can be expressed by a given equation. For example, a gain group may be a value expressed by Equation (1) given below.

gmi=k₁+k₂i (1)

where i=0, 1, . . . , Lj−1, k₁ and k₂ are predetermined values set as appropriate, and i is a gain code. The same equation may be used for different gain groups or different equations may be used for different gain groups. Gains and an equation (s) stored in the gain group set storage 113 are not limited to the gains illustrated in FIG. 9 and the equation given above. Gains and an equation (s) are determined by experiment or otherwise beforehand.

“Difference Signal Calculating Part 115”

The difference signal calculating part 115 multiplies a sample ym by each gain gmi in the gain group allocated to the sample and subtracts the product from the input signal xm to obtain a difference signal dmi (s115).

For example, the difference signal dmi is obtained according to the following equation:

dmi=∥xm−gmi×ym∥ (2)

For example, the difference signal calculating part 115 includes a multiplier 1151 and a subtracter 1152. The multiplier 1151 multiplies a first-layer decoded signal sample ym by a gain gmi. The resulting value is subtracted from the input signal xm to obtain a difference signal dmi. Instead of Equation (2), the equation

dmi=(xm−gmi×ym)² (3)

may be used to obtain the difference signal. In this case, a squarer, not depicted, is provided to square (xm−gmi×ym) to obtain the difference signal dmi. The difference signal may be calculated according to an expansion of Equation (3), (dmi=xm²−2 gmi×xm×ym+gmi²×ym²), or the expansion excluding the first term of the right-hand side, which is the constant term in the expansion, that is, (dmi=−2 gmi×xm×ym+gmi²×ym²).

The multiplier 1151 and the subtracter 1152 do not necessarily need to be disposed in sequence; the calculation process may be performed in an IC or the like as long as the difference signal can be obtained according to an equation such as Equation (2) or (3).

“Gain Selecting Part 119”

The gain selecting part 119 selects, for each sample ym, a gain gmi that results in the smallest difference signal dmi from the gain group and outputs information about the selected gain as a second-layer code C2 (s119). The information about the gain is a gain code, for example. The gain selecting part 119 may output gain codes for the samples in one frame at a time as a second-layer code C2. The gain selecting part 119 receives a difference signal dm and, upon completion of comparison of a given gain gmi, outputs a control signal to the gain group set storage 113 to control the process so that a difference signal for the next gain gm(i+1) is calculated.

<Process Flow in Second-Layer Encoding Part 110>

An exemplary process flow in the second-layer encoding part 110 will be described with reference to FIGS. 8 and 9. The second-layer encoding part 110 receives one frame of a first-layer decoded signal ym and an input signal xm. First, initialization is performed (s110a). Here, m denotes a sample identification number, i denotes a gain code, dmin denotes the minimum difference signal value, k denotes an adequately large number. The allocation part 111 allocates bit allocation information bm to a sample ym of the first-layer decoded signal (s111). Based on the allocated bit information bm (s112), the allocation part 111 allocates a gain group to the sample ym (s113). For example, if bm=2 in FIG. 9, the allocation part 11 allocates the gain group 1132 (s1132). A gain gmi is output from the allocated gain group. The difference signal calculating part 115 multiplies the first-layer signal sample ym by the gain gmi (s1151), subtracts the product from the sample xm of the input signal (s1153) to obtain a difference signal dmi (s115). The gain selecting part 119 determines whether or not the smallest value dmin among the difference signal values obtained so far for the sample ym is greater than the current difference signal dmi (s116). If the previously obtained smallest difference signal dmin is greater, the gain selecting part 119 updates the minimum difference signal value dmin to the difference signal dmi obtained at s115 and sets the current i as a gain code c2m (s117). The selecting part 119 determines whether or not the gain is the last gain in the gain table (s118). If it is not the last gain, steps s115 to s118 are repeated on the next gain (s1181). After steps s115 to s118 have been performed on all gains in the gain table, the gain selecting part 119 selects a gain code c2m corresponding to the finally updated dmin (s119). Determination is made as to whether the sample ym corresponding to the gain code c2m is the last sample in the frame (s121). If the sample ym is not the last sample, steps sill to s119 are repeated on the next sample (s122). After steps sill to s119 have been performed on all samples in the frame, the set of the gain codes selected (c20, c21, . . . , c2(M−1)) is output as a second-layer code C2 (s123).

If the allocation part 111 does not allocate a gain table to the sample ym, depending on bit allocation information bm (s1134), steps 115 to s119 on that sample may be omitted and may be performed on the next sample. This can reduce the amount of computation and the amount of information of the code to be sent. In this case, a gain code gm for the sample ym is not contained in the second-layer code C2 and therefore the number of gain codes N included in C2 is less than or equal to the number of samples M in the frame.

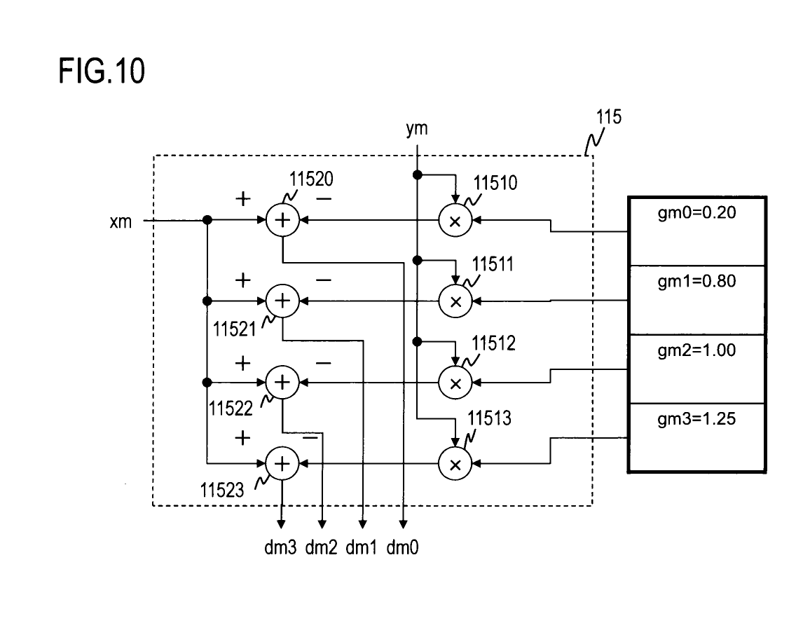

While steps s115 to s118 are repeated in the foregoing, difference signals dm0, dm1, . . . , dm(Lj−1) for all gains gm0, gm1, . . . , gm(Lj−1) allocated to one sample may be obtained at a time in the difference signal calculating part 115 and the smallest dmi may be selected in the gain selecting part 119. FIG. 10 illustrates an exemplary configuration of the difference signal calculating part 115 that obtains difference signals at a time. All gains gm0, gm1, . . . , gm(Lj−1) in an allocated gain group are input in the difference signal calculating part 115. Each corresponding multiplier 1151i multiplies the first-layer decoded signal sample ym by the gain. Each corresponding subtracter 1152i subtracts the product from the input signal sample xm to obtain difference signal dm0, dm1, . . . , dm(Lj−1). The gain selecting part 119 selects the smallest one dmin of the difference signals, selects the gain code i corresponding to the smallest difference signal dmin, and sets the set of gain codes for all samples in the frame as a second-layer code C2.

<Effects>

The scalar quantization of gains in the second-layer encoding part 110 has the effect of significantly reducing the amount of computation in encoding as compared with the existing technique that performs vector quantization in second-layer encoding. In general, it is effective for maximizing the SNR of input and output signals to allocate many bits to samples with large amplitudes. A characteristic of vector quantization is that a vector corresponding to a code can be decoded as an amplitude larger than the amplitude of an input signal sample even if the amplitude of the sample is relatively small. According to the present invention, gain groups including more gains are allocated to samples with larger amplitudes, thereby reducing the error. Furthermore, the bit allocation algorithm in Reference Literatures 1 or 2 can be used in the allocation part 111 to provide a gain code as an output code to reduce the amount of information. The method of the present invention provides an output signal with a higher quality than an output signal of a method, for example, in which the allocation part is not provided, vector quantization is used in combination with scalar quantization, and a single gain group set is used, if the amounts of information of second-layer codes in both methods are the same. This is because the method of the present invention allocates more gains to a sample that would provide a large difference between the input signal xm and the first-layer decoded signal ym. In other words, a gain that results in a smaller difference between gains and therefore a smaller difference signal value can be selected. Furthermore, the present invention can use a second-layer code with a smaller amount of information to provide an output signal with the same quality as that provided by such a method.

[Decoding Device 200]

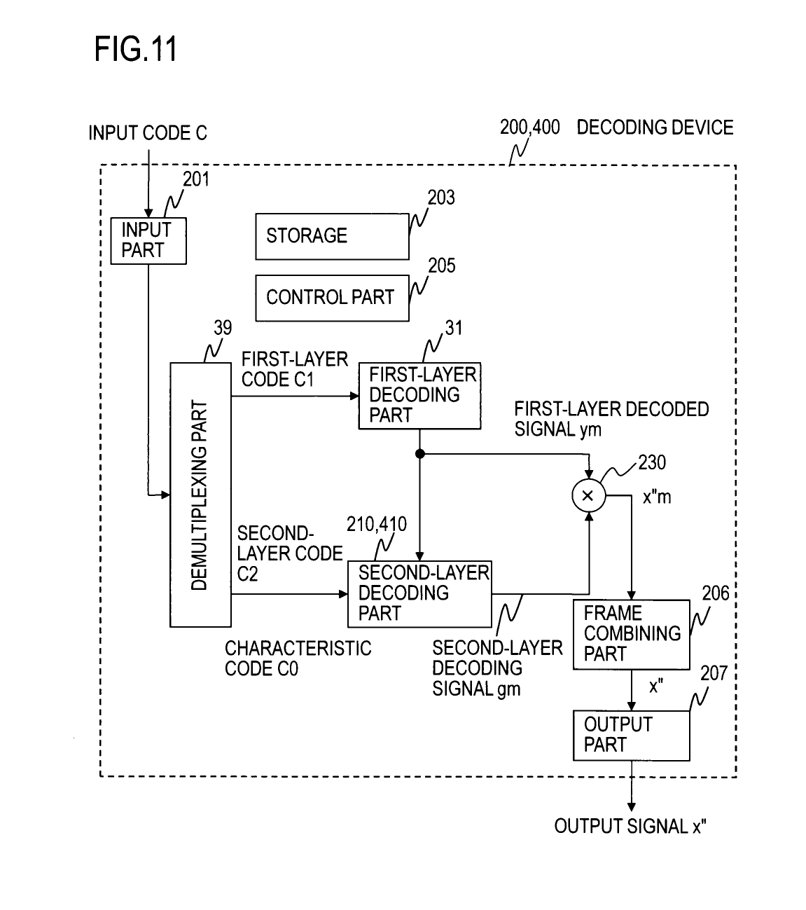

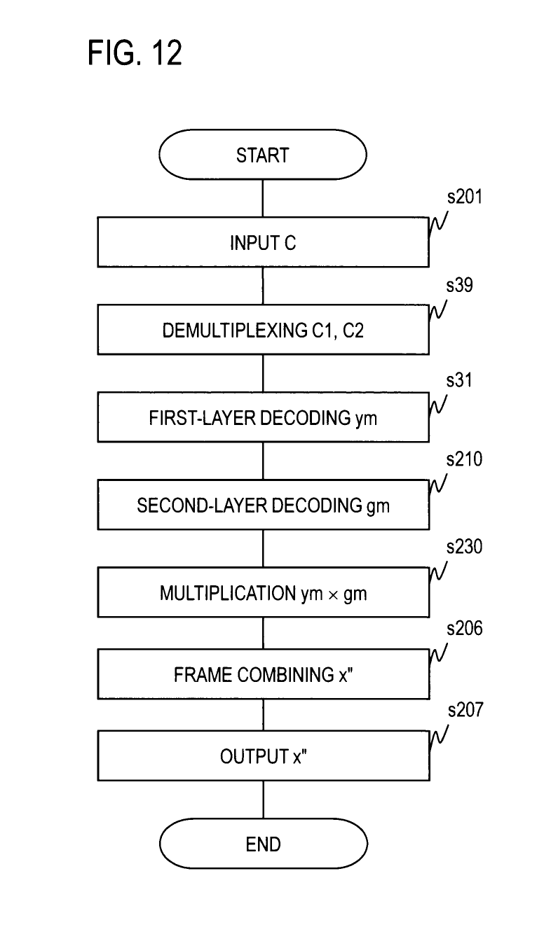

FIG. 11 illustrates an exemplary configuration of a decoding device 200 and FIG. 12 illustrates an exemplary process flow in the decoding device 200. The decoding device 200 includes an input part 201, a storage 203, a control part 205, a demultiplexing part 39, a first-layer decoding part 31, a multiplier 230, a frame combining part 206, an output part 207 and a second-layer decoding part 210.

<Input Part 201, Storage 203, Control Part 205 and Output Part 207>

The input part 201, the storage 203 and the control part 205 have configurations similar to those of the input part 101, the storage 103 and the control part 105 of the encoding device 100.

The decoding device 200 receives an output code C output from the encoding device 100 as an input code through the input part (s201).

<Demultiplexing Part 39>

The demultiplexing part 39 separates the input code C including a first-layer code C1 and a second-layer code C2 to extract the first- and second-layer codes C1 and C2 (s39).

<First-Layer Decoding Part 31>

The first-layer decoding part 31 decodes the first-layer code C1 using a first-layer decoding scheme to obtain a first-layer decoded signal ym (s31). The first-layer decoding scheme is complementary to the first-layer encoding scheme used in the first-layer encoding part 21 of the encoding device 100. The first-layer decoding part 31 may have the same configuration as the first-layer decoding part 23.

The second-layer decoding part 210 decodes the second-layer code C2 using a second-layer decoding scheme to obtain a second-layer decoded signal gm (s210). The second-layer decoding part 210 will be detailed later.

<Multiplier 230>

The multiplier 230 multiplies the first-layer decoded signal ym by the second-layer decoded signal (gain) gm (s230) and outputs an output signal x″m.

<Frame Combining Part 206 and Output Part 207>

The frame combining part 206 combines frames into continuous time-sequence data x″ and outputs the data x″ (s206). The decoding device 200 outputs the output signal x″ through the output part 207 (s207).

<Second-Layer Decoding Part 210>

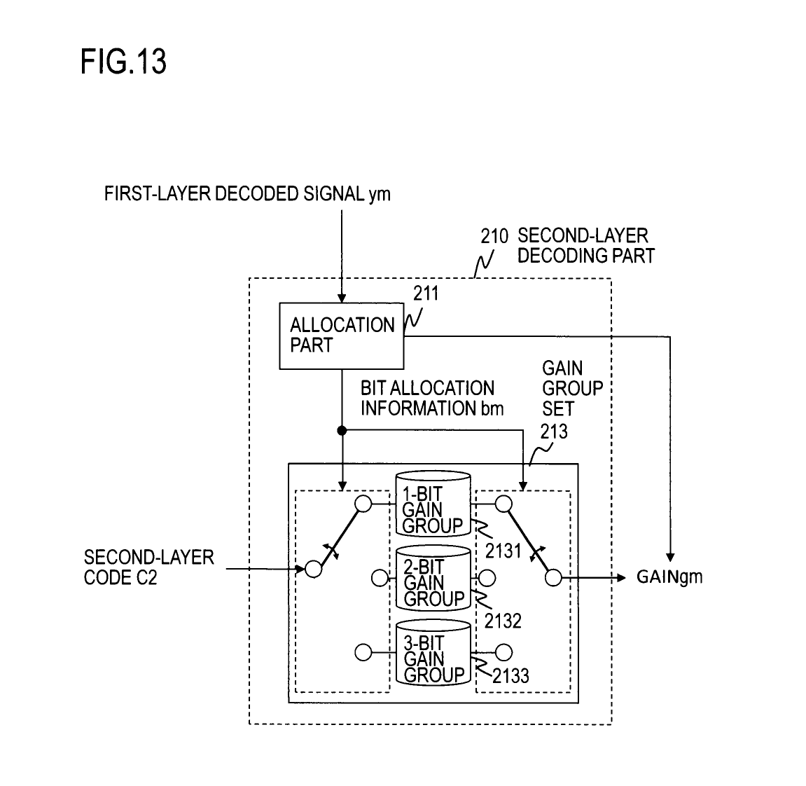

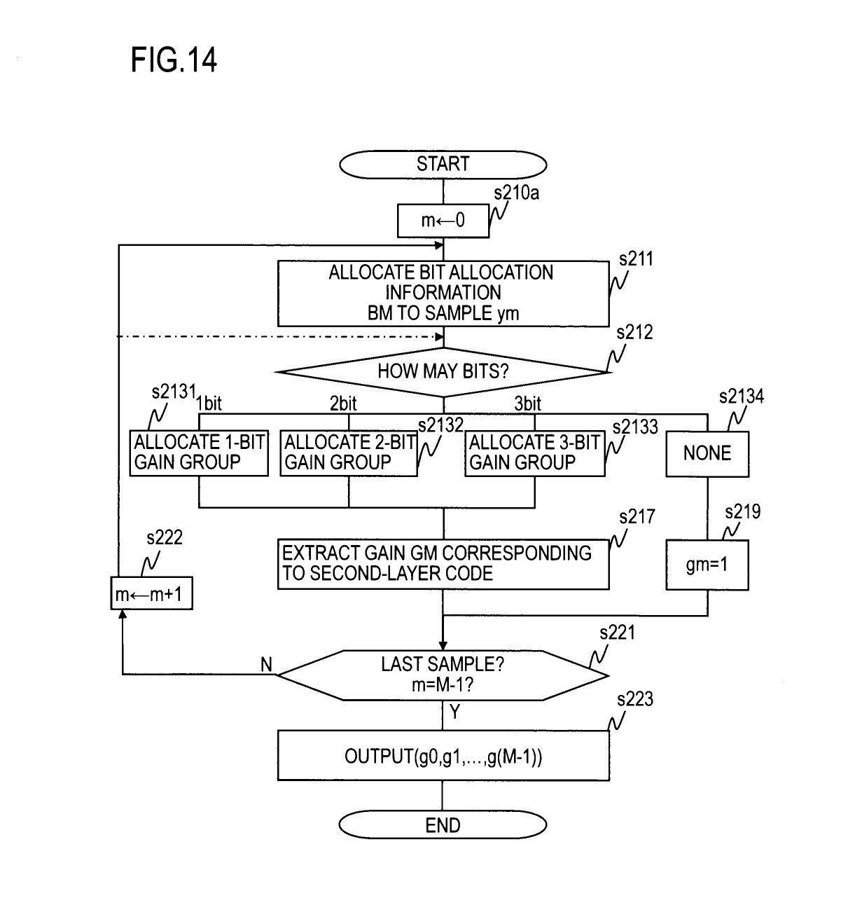

FIG. 13 illustrates an exemplary configuration of the second-layer decoding part 210 and FIG. 14 illustrates an exemplary process flow in the second-layer decoding part 210. The second-layer decoding part 210 includes an allocation part 211 and a gain group set storage 213.

“Allocation Part 211”

The allocation part 211 allocates a gain group to each sample ym of the first-layer decoded signal. The allocation part 211 allocates gain groups including more gains to samples that have greater auditory impacts. The allocation part 211 has a configuration similar to that of the allocation part 111 of the encoding device 100 which has generated the input code C.

“Gain Group Set Storage 213”

The gain group set storage 213 has a configuration similar to that of the gain group set storage 113 of the encoding device 100 which has generated the input signal C and stores a gain group set similar to that in the gain group set storage 113.

<Process Flow in Second-layer Decoding Part 210>

Referring to FIG. 14, an exemplary process flow in the second-layer decoding part 210 will be described. One frame of a first-layer decoded signal ym and a second-layer code C2 is input in the second-layer decoding part 210. First, initialization is performed (s210a). Here, m denotes an identification number of a sample. The allocation part 211 allocates bit allocation information bm to a sample ym of the first-layer decoded signal (s211) and, based on the allocated bit information bm (s212), allocates a gain group to the sample ym (s213). For example, a gain table 2132 is allocated to the sample ym (s2132). The second-layer decoding part 210 extracts a gain gm corresponding to a second-layer code from among gains contained in the allocated gain table (s217). If the allocation part 211 does not allocate a gain group to the sample ym (s2134), step s217 is not performed on the sample and gain gm=1 is set for the sample (s219). This enables M gains to be obtained from N gain codes (M≧N) and can reduce the amount of information of the code. Determination is made as to whether the sample ym is the last sample in the frame (s221). If it is not the last sample, steps s211 to s219 are repeated on the next sample (s222). After step s211 to s219 have been performed on all samples in the frame, gains are output as a second-layer decoded signal gm (s223).

<Effects>

The encoding and decoding devices configured as described above can accomplish scalable encoding that involves only a small amount of computation and information. The decoding device can extract an output signal by providing only the first-layer decoded signal ym through decoding. The decoding device also can provide an output signal with a high quality by using a second-layer decoded signal gm. Furthermore, the provision of the allocation parts in both devices enables decoding without needing to contain allocation information in an output code. Thus, the amount of information of the code can be reduced.

[First Variation]

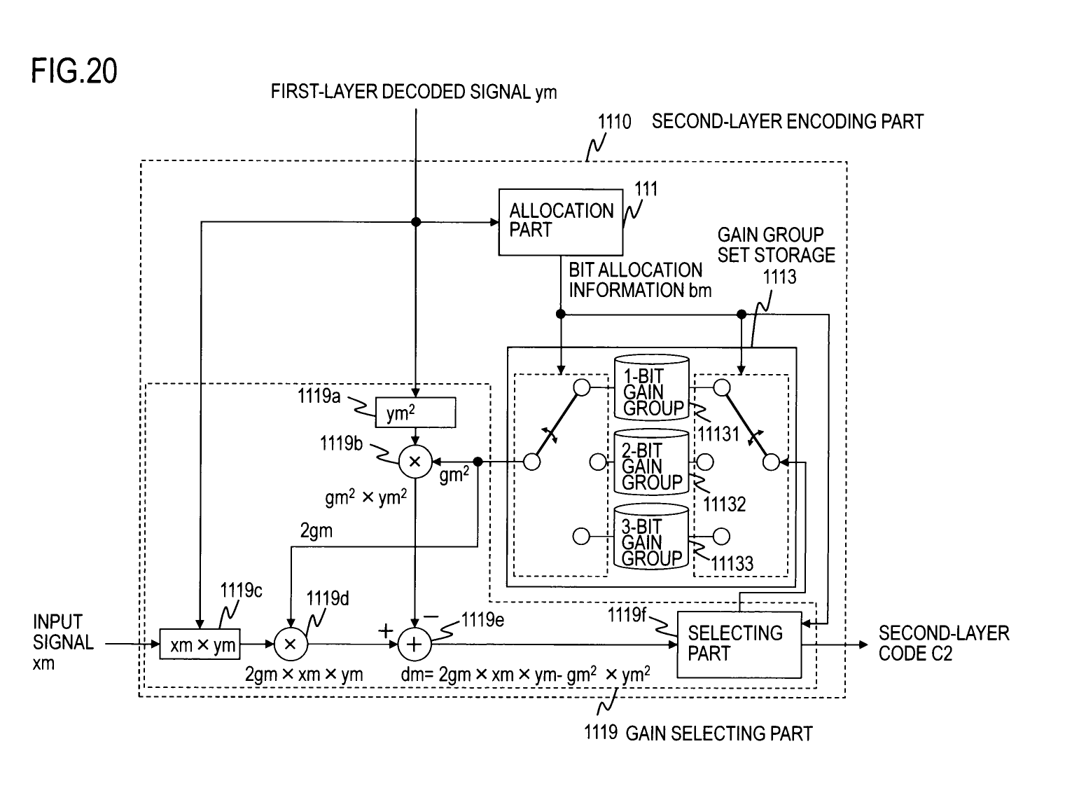

Only differences from the first embodiment will be described. Referring to FIG. 20, a second-layer encoding part 1110 will be described. Elements in FIG. 20 that are equivalent to those in FIG. 7 are labeled the same numerals and description of those elements will be omitted. The same applies to the subsequent drawings. The second-layer encoding part 1110 includes a bit allocation part 111, a gain group set storage 1113, and a gain selecting part 1119.

<Gain Group Set Storage 1113>

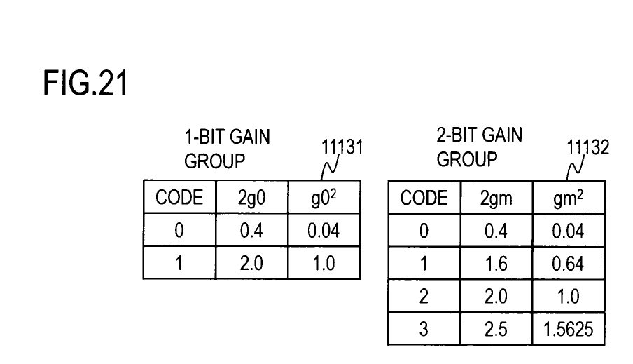

The gain group set storage 1113 stores a gain group set. FIG. 21 illustrates an example of data in a 1-bit gain group and a 2-bit gain group. The gain group set includes J gain groups (for example three gain groups 11131, 11132 and 11133). Each of the gain groups includes values corresponding to Lj gains. The gain group set storage 1113 also stores gain codes representing values corresponding to the gains. The value corresponding to a gain is a notion including, for example, the gain gmi itself, the gain gmi multiplied by a constant (2 gmi), the square of the gain (gmi²) and a combination of these. In this variation, the value corresponding to a gain is a combination of 2 gmi and gmi².

<Gain Selecting Part 1119>

The gain selecting part 1119 outputs a gain code i indicating a gain gmi that results in the smallest difference between the input signal xm and a sample multiplied by the gain, gmi×ym, among the gains in the gain group allocated to the sample.

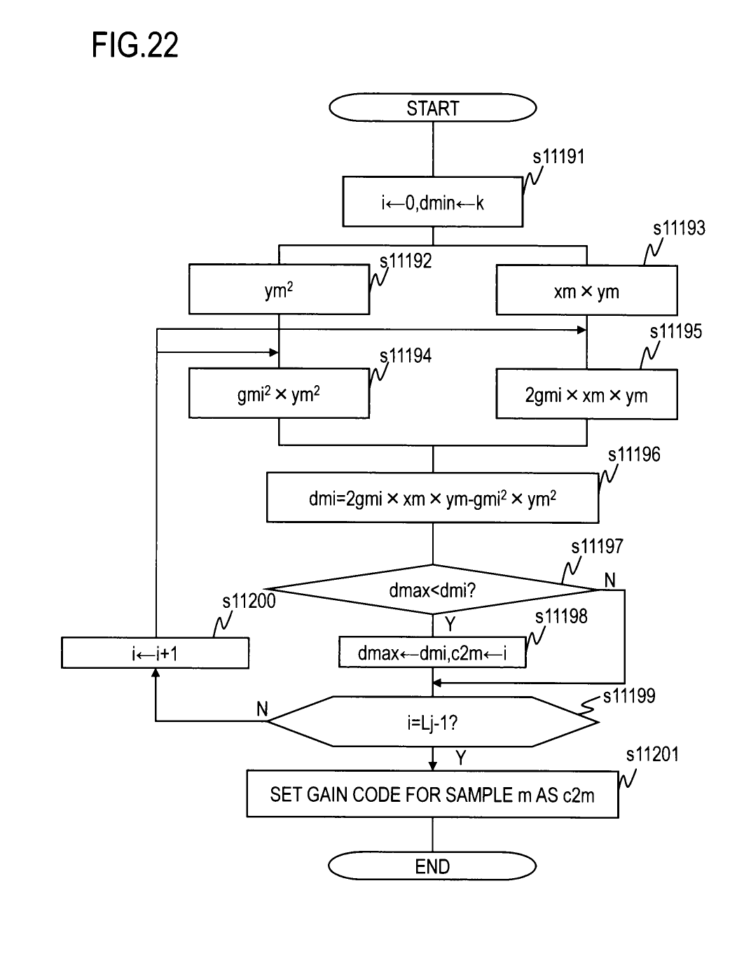

The gain selecting part 1119 includes a squarer 1119a, multipliers 1119b, 1119c and 1119d, a subtracter 1119e, and a selector 1119f. Referring to FIG. 22, a process flow in the gain selecting part 1119 will be described below.

The gain selecting part 1119 first performs initialization (s11191).

The squarer 1119a receives a first-layer decoded signal ym, uses the first-layer decoded signal ym to calculate ym² and sends ym² to the multiplier 1119b (s11192).

The multiplier 1119b receives a value gmi² corresponding to a gain gmi (i=0, 1, . . . , Lj−1) from the gain group 1113j (j=1, 2, . . . , J) allocated by the allocation part 111 to each sample ym of the first-layer decoded signal, calculates gmi²×ym², and sends the result to the subtracter 1119e (s11194).

The multiplier 1119c receives the first-layer decoded signal sample ym and an input signal sample xm, calculate xm×ym, and sends the result to the multiplier 1119d (s11193).

The multiplier 1119d receives a value 2 gmi corresponding to the gain gmi from the gain group 1113j, calculates 2 gmi×xm×ym, and sends the result to the subtracter 1119e (s11195).

The subtracter 1119e calculates dmi=2 gmi×xm×ym−gmi²×ym² and sends the result dmi to the selector 1119f (s11196).

The selector 1119f determines whether or not the value dmax obtained for the sample ym so far is smaller than the current value dmi (s11197). If it is smaller, the value dmax is updated to the value dmi obtained at s11196 and sets the current i as a gain code c2m (s11198). Determination is made as to whether or not the gain is the last gain in the gain table (s11199). If it is not the last gain, steps s11194 to s11199 are repeated on the next gain (s11200).

The gain selecting part 1119 performs steps s11194 to s11199 on all gains in the gain table and selects a gain code c2m corresponding to the finally updated dmax (s11201).

The following process is performed in the second-layer encoding part 1110. Determination is made as to whether or not the sample ym corresponding to the gain code c2m is the last sample in the frame. If it is not the last sample, steps 11191 to s11201 are repeated on the next sample. After steps s11191 to s11201 are performed on all samples in the frame, a set of the gain codes selected (c20, c21, . . . , c2(M−1)) is output as a second-layer code C2.

In the first embodiment, the gain code is selected on the basis of the equation (dmi=xm²−2 xm×gmi×ym+gmi²×ym²), or the gain code corresponding to the smallest dmi calculated according to the equation (dmi=−2 gmi×xm×ym+gmi²×ym²), which is an expansion excluding the first term, a constant term, of the right-hand side of the equation. This is equivalent to selecting the gain code corresponding to the largest dmi calculated according to the equation (dmi=2 gmi×xm×ym−gmi²×ym²).

<Effects>

The configuration described above has the same effects as the encoding device 100 of the first embodiment. In addition, the amount of computation in the gain selecting part 1119 can be reduced by storing values such as gmi² and 2 gmi that correspond to the gains in the gain group set storage 1113, in place of the gains. Furthermore, by calculating ym² and xm×ym in the multipliers 1119a and 1119c and storing the resulting values beforehand, the amount of computation required for (Lj−1) iterations of calculations of ym² and xm×ym in calculating 2 gmi×xm×ym and gmi²×ym² can be reduced. However, the gain selecting part 1119 may use other method to provide a gain code that indicates a gain that results in the smallest difference between the input signal and a sample multiplied by the gain among the gains in the gain group allocated to the sample. The elements 1119a to 1119e may be integrated into a single module, for example.

[Second Variation]

Only differences from the first embodiment or the first variation will be described. Processing by the allocation part 111 of the encoding device 100 and the allocation part 211 of the decoding device 200 in the second variation differs from the processing in the first embodiment or the first variation.

The allocation part 111 of the second variation obtains the number of bits to be allocated to all samples in a frame (bit allocation information bm). Accordingly, the second-layer encoding part 110 of the encoding device 100 performs allocation of bit allocation information bm (s111) for the same frame only once as indicated by the alternate long and short dashed lines in FIG. 8. Then steps s112 to s121 are repeated.

Similarly, the allocation part 211 of the second variation obtains the number of bits to be allocated to all samples in the frame (bit allocation information bm). The second-layer decoding part 210 of the decoding device 200 performs allocation of bit allocation information bm (s211) for the same frame only once as indicated by the alternate long and short dashed lines in FIG. 14. Then steps s212 to s221 are repeated.

As in the first embodiment and the first variation, the allocation part 111 and the allocation part 211 allocate gain groups including more gains to samples ym of the first-layer decoded signal that have greater auditory impacts (s111, s211). Whether the auditory impact of each sample is great or not is determined on a frame-by-frame basis using the same method as in the first embodiment and the first variation. The same bit allocation information bm is allocated to the samples in the same frame.

[Other Variations]

The encoding device 100 in the first embodiment includes first-layer encoding part 21 and the first-layer decoding part 23. The essence of the present invention is that a gain group is allocated to each sample ym of the first-layer decoded signal by using a predetermined method in the second-layer encoding part, a gain gm identified by a value corresponding to each gain in the allocated gain group is multiplied by the sample ym, a second-layer code (gain code) indicating a gain that results in the smallest difference between the product and the input signal xm is obtained, and the second-layer code is used to perform encoding and decoding. Accordingly, the encoding device 100 may have a configuration that includes only the second-layer encoding part, uses as inputs a first-layer decoded signal ym and an input signal xm generated by a conventional scalable encoding device to obtain a second-layer code, and outputs a second-layer code to the conventional scalable encoding device. The first-layer code and the second-layer code are multiplexed in the conventional scalable encoding device and output.

While the allocation part 111 of the encoding device 100 allocates gain groups including more gains to samples ym of the first-layer decoded signal that have greater auditory impacts, the allocation part 111 may use other method to allocate gain groups, provided that the decoding device 200 uses the same method as the allocation part 111 to allocate gain groups.

### Second Embodiment

Only differences from the first embodiment will be described.

[Coding Device 300]

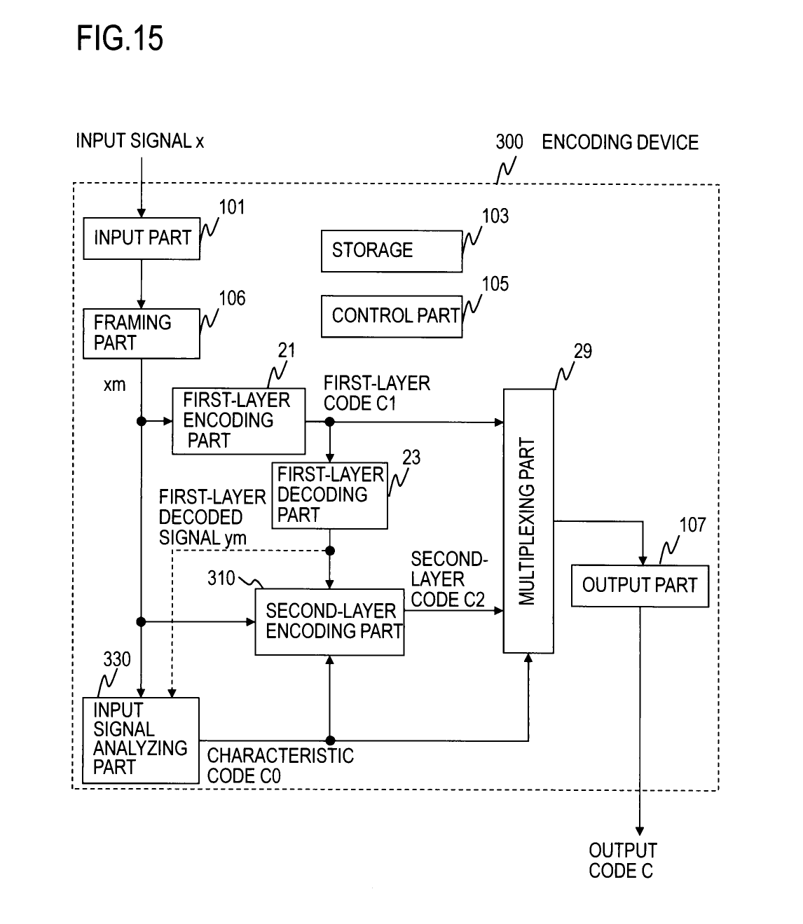

FIG. 15 illustrates an exemplary configuration of a encoding device 300. The encoding device 300 includes an input signal analyzing part 330 in addition to the components of the encoding device 100. The second-layer encoding part 310 of the encoding device 300 differs in configuration and processing from that of the encoding device 100.

<Input Signal Analyzing Part 330>

The input signal analyzing part 330 analyzes a characteristic of an input signal on a frame-by-frame basis to obtain a characteristic code C0. For example, the input signal analyzing part 330 analyzes the input signal to determine whether there are significant differences in amplitude distribution of samples among frames. The input signal analyzing part 330 receives an input signal xm or a first-layer decoded signal ym and uses one of theses signals to analyze the characteristic of the input signal.

<Second-Layer Encoding Part 310>

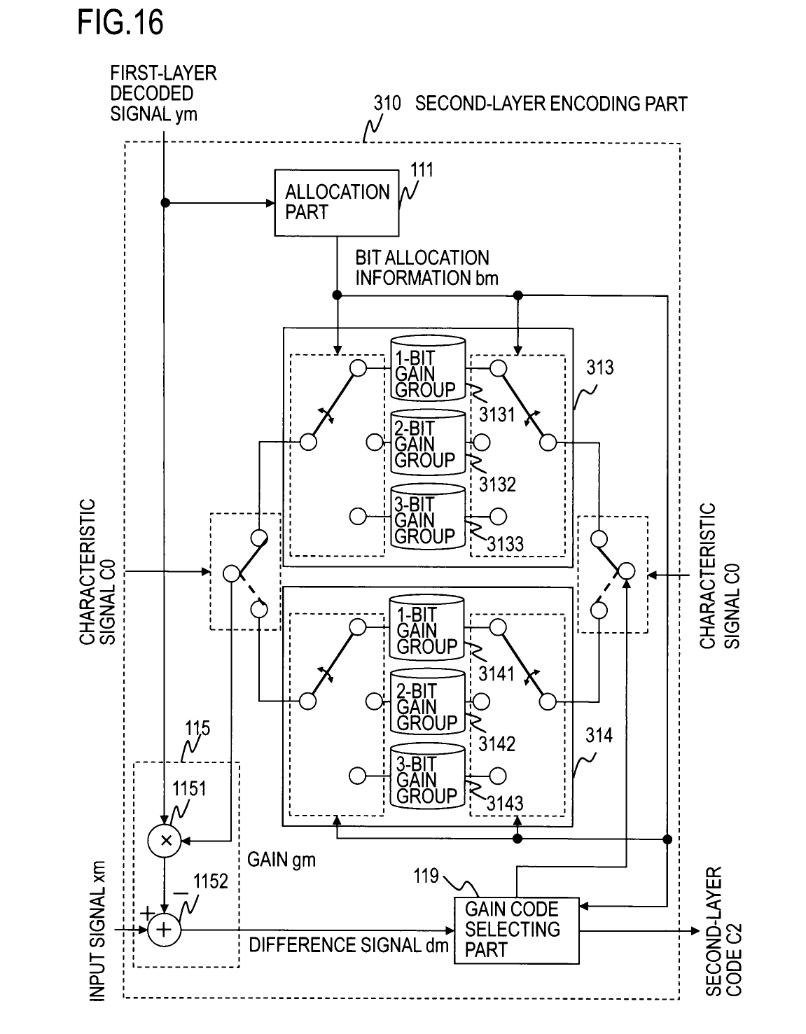

FIG. 16 illustrates an exemplary configuration of the second-layer encoding part 310. The second-layer encoding part 310 includes multiple gain group set storages 313, 314, for example. The gain group set storages 313, 314 contain different gain groups. For example, the gain group set 313 contains gain groups 3131, 3132 and 3133. One of the gain group sets stores many gains that are close to 0 for harmonic signals and the other gain group set stores gains (for example gains shown in FIG. 9) for white noise signals.

The second-layer encoding part 310 uses the characteristic code C0 to select one of the gain group sets. For example, if C0=0, the second-layer encoding part 310 selects the gain group set 313; if C0=1, the second-layer encoding part 310 selects the gain group set 314.

The allocation part 111 allocates a gain group in the selected gain group set to each sample ym.

The characteristic code C0 is input in a multiplexing part 29 in addition to a first-layer code C1 and a second-layer code C2. The multiplexing part 29 multiplexes the signals C1, C2 and C0 into an output code C on a frame-by-frame basis and outputs the output code C. FIG. 6B illustrates an example of data of the output code for one frame of an input signal in the encoding device 300.

[Decoding Device 400]

FIG. 11 illustrates an exemplary configuration of a decoding device 400. The decoding device 400 has a second-layer decoding part 410 that differs in configuration and processing from the second-layer decoding part of the first embodiment. A demultiplexing part 39 separates the input code C back into the first-layer code C1, the second-layer code C2 and the characteristic code C0.

<Second-Layer Decoding Part 410>

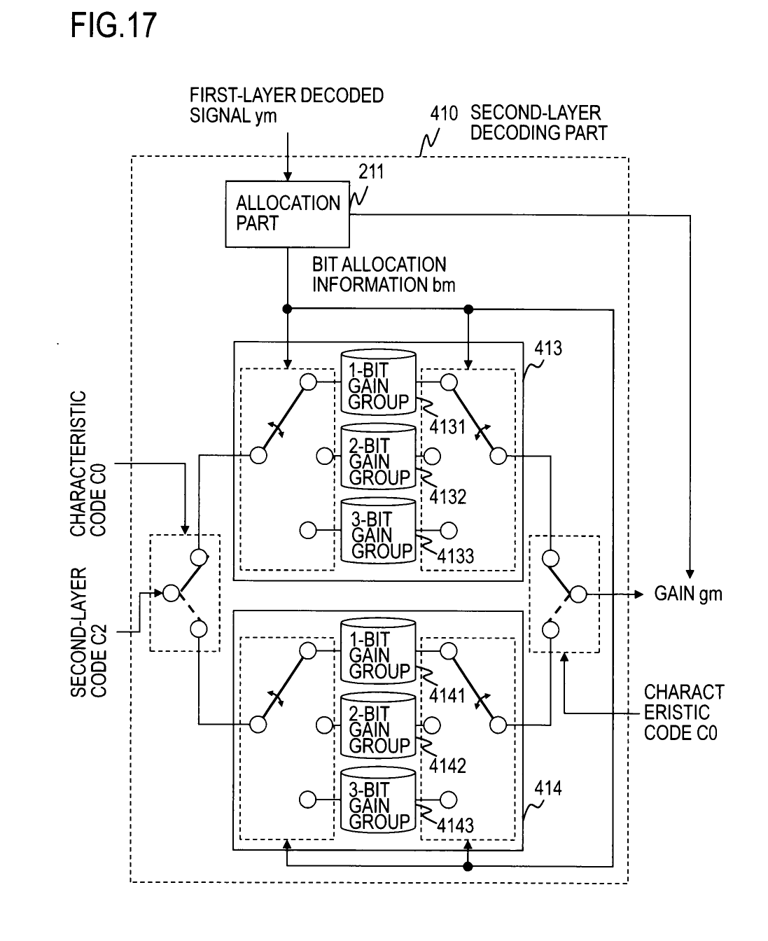

FIG. 17 illustrates an exemplary configuration of the second-layer decoding part 410. The second-layer decoding part 410 includes multiple gain group set storages 413, 414. The gain group set storages 413, 414 store the same information as the gain group set storages 313, 314.

The second-layer decoding part 410 uses the characteristic code C0 to select one of the gain group sets.

An allocation part 211 allocates a gain group in the selected gain group set to each sample ym.

The rest of the configuration and processing are the same as those of the second-layer decoding part 210 of the first embodiment.

<Effects>

With the configuration described above, the same effects as those of the first embodiment can be attained. In addition, a gain group set appropriate to a characteristic of the input signal can be allocated. For example, if there are significant differences in amplitude distribution of samples among frames of a signal, for example if a coefficient in the frequency domain of a harmonic signal is encoded using vector quantization, it is difficult because of the characteristics of vector quantization to provide a code that is decoded as a very small amplitude to samples other than peaks of the harmonic signal. The present invention can reduce distortion in the first-layer caused by vector quantization to improve the SNR by providing values close to 0 in a gain group in the second-layer.

### Third Embodiment

Only differences from the first embodiment will be described.

[Coding Device 500]

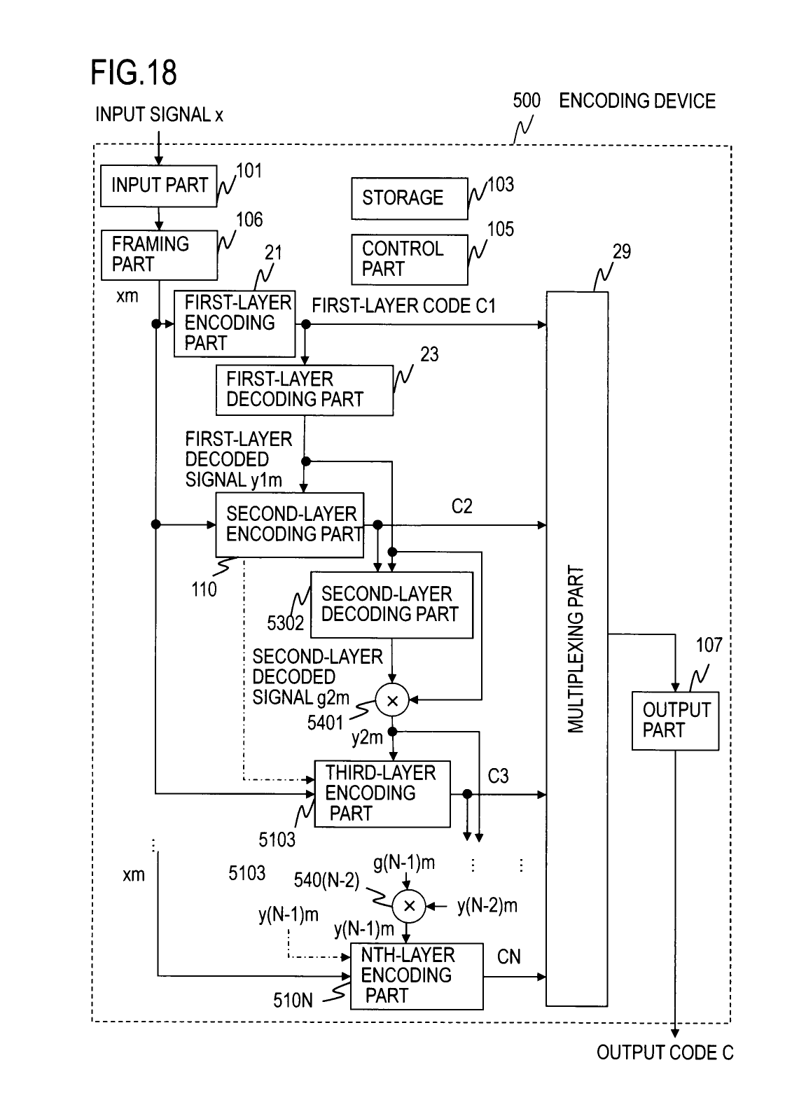

FIG. 18 illustrates an exemplary configuration of a encoding device 500. The encoding device 500 includes a number N of nth-layer encoding parts (where N is an integer greater than or equal to 3 and n=3, 4, . . . , N), a number (N−1) of (n−1)-th-layer decoding parts, and a number (N−2) of (n−2)-th multipliers, in addition to the components of the encoding device 100.

<(n−1)-th-Layer Decoding Part>

The (n−1)-th-layer decoding part uses a first-layer decoded signal or a value y(n−2)m output from the (n−3)-th multiplier and an (n−1)-th-layer code C(n−1) to obtain an (n−1)-th-layer decoded signal. For example, if n=3, the second-layer decoding part 5302 uses a first-layer decoded signal y1m and a second-layer code C2 to obtain a second-layer decoded signal g2m. If n>3, for example if n=4, an output value y2m output from the first-layer multiplier 5401 and a third-layer code C3 output from the third-layer encoding part 513 are used to obtain a third-layer decoded signal g3m. The (n−1)-th-layer decoding part has the same configuration as the second-layer decoding part 210 illustrated in FIG. 13. If n>3, an output value from the (n−3)-th multiplier and an (n−1)-th-layer code C (n−1), instead of the first-layer decoded signal and the second-layer code C2, are input in the second-layer decoding part 210.

Each of the (n−1)-th-layer decoding parts includes an allocation part that allocates a gain group to each sample of the first-layer decoded signal or an output value output from the (n−3)-th multiplier. The allocation part allocates gain groups including more gains to samples having greater audible impacts. The (n−1)-th-layer decoding part extracts a gain that corresponds to the (n−1)-th-layer code from the gain group and outputs as an (n−1)-th-layer decoded signal.

<(n−2)-th Multiplier 540(n−2)>

The (n−2)-th multiplier 540(n−2) multiplies the first-layer decoded signal or the output value y(n−2)m output from the (n−3)-th multiplier by the (n−1)-th-layer decoded signal g(n−1)m. For example, if n=3, the first multiplier 5401 multiplies the first-layer decoded signal y1m by the second-layer decoded signal g2m to output a signal y2m that approximates to the input signal xm. If n>3, for example if n=4, the value y2m output from the first multiplier 5401 is multiplied by the third-layer decoded signal C3 to output a signal y3m that approximates to the input signal xm.

<nth-Layer Encoding Part 510n>

The nth-layer encoding part 510n uses the input signal xm and the value y (n−1)m output from the (n−2)-th multiplier to obtain an nth-layer code Cn. The nth-layer encoding part 510n has the same configuration as the second-layer encoding part in FIG. 7 and receives the value y(n−1)m output from the (n−2)th multiplier, instead of the first-layer decoded signal ym. For example, the third-layer encoding part 5103 uses the input signal xm and the value y2m output from the first multiplier 5401 to obtain the third-layer code C3.

A multiplexing part 29 multiplexes the first to nth-layer codes C1 to CN into an output code C and outputs the code C.

[Decoding Device 600]

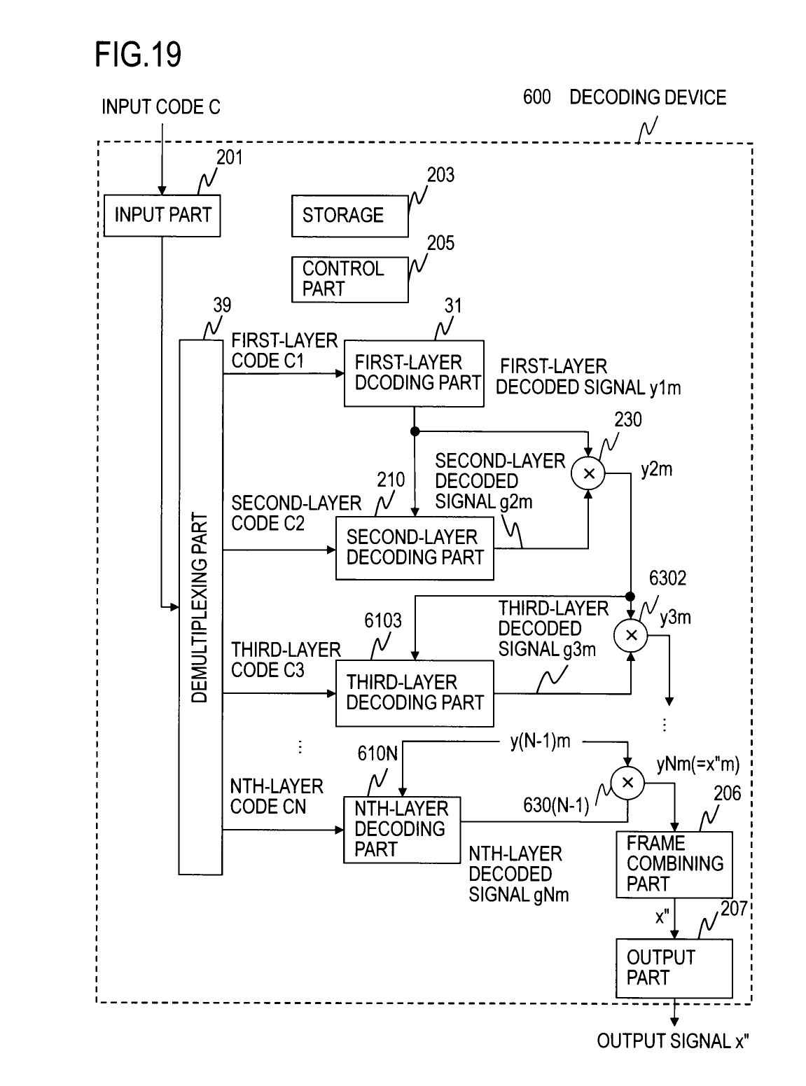

FIG. 19 illustrates an exemplary configuration of a decoding device 600. The decoding device 600 includes a number N of nth-layer decoding parts and a number (N−1) of (n−1)-th multipliers, in addition to the components of the decoding device 200.

A demultiplexing part 39 takes the first- to Nth-layer codes C1 to CN from the input code and outputs the codes C1 to CN to the first- to Nth-layer encoding parts.

<nth-Layer Decoding Part 610n>

The nth-layer decoding part 610n includes an allocation part which allocates a gain group to each sample y(n−1)m of a value output from the (n−2)-th multiplier. The allocation part allocates gain groups including more gains to samples that have greater auditory impacts. The nth-layer decoding part 610n extracts a gain corresponding to an nth-layer code from the gain group and outputs the gain as an nth-layer decoded signal gnm. For example, if n=3, the third-layer decoding part 6103 uses a value y2m output from the first multiplier 230 and a third-layer code C3 to output a third-layer decoded signal g3m.

<(n−1)-th Multiplier 630(n−1)>

The (n−1)-th multiplier multiplies the value y(n−1)m output from the (n−2)-th multiplier by the nth-layer decoded signal gnm. For example, if n=3, a second multiplier 6302 uses the value y2m output from the first multiplier 230 and the third-layer decoded signal g3m output from the third-layer decoding part 6103 to obtain y3m. An output signal yNm (=x″m) obtained in the (N−1) multiplier 630(N−1) is output to a frame combining part 206.

<Effects>

With the configuration described above, the same effects as those of the first embodiment can be attained. In addition, the multilayered structure can improve the SNR.

[First Variation]

Only differences from the third embodiment will be described. In this variation, the (n−1)-th-layer decoding part and the (n−2)-th multiplier 540(n−2) are not provided.

An (n−1)-th encoding part 510(n−1) (a second-layer encoding part 110 if n=3) outputs the result of calculation y(n−1)m=g(n−1)mi×y(n−2)m when a gain code c(n−1)m is obtained for each input signal sample xm directly to an n-th-layer encoding part 510n as indicated by alternate long and short dashed lines in FIG. 18. For example, a multiplier 11151 in a second-layer encoding part 110 can obtain the result of the calculation gmi×ym. Such results are stored and gmi×ym that corresponds to a gain code i(c2m) selected by the gain selecting part 119 is output to the third-layer encoding part 5103.

The input signal xm and the result of calculation y(n−1)m are input in an nth-layer encoding part 510n. The nth-layer encoding part 510n has the same configuration as the second-layer encoding part 110 illustrated in FIG. 7. The nth-layer encoding part 510n allocates bit allocation information bm to each input sample y(n−1)m and allocates a gain group to the sample y(n−1)m on the basis of the bit allocation information bm. The nth-layer encoding part 510n obtains a gain gnmi that results in the smallest difference between the input signal sample xm and the sample y(n−1) multiplied by the gain among the gains in the gain group, and outputs a gain code cnm indicating the gain gnmi. That is, the encoding method is the same as that of the second-layer encoding part 110 illustrated in FIG. 7. However, the gain groups in the gain group set are different.

If bit allocation information bm is 0, that is, if no gain group is allocated, the nth-layer encoding part 510n may set gm=1 and may directly output the result y(n−1)m of calculation by the (n−1)-th encoding part 510(n−1) as the result ynm of calculation by the nth-layer encoding part 510n.

With the configuration described above, the same effects as those of the third embodiment can be attained. In addition, the amount of computation in the nth-layer encoding parts 510n can be reduced.

[Program and Storage Medium]

The function of the encoding devices 100, 300 and 500 and the decoding devices 200, 400 and 600 described above can be implemented by a computer. A program for causing the computer to function as an intended device (a device including functions and the configuration illustrated in drawings in any of the embodiments) or a program for causing the computer to execute the steps of process procedures (illustrated in any of the embodiments) may be downloaded from a recording medium such as a CD-ROM, a magnetic disk, or a semiconductor memory device into the computer, or may be downloaded to the computer through a communication line and the computer may be caused to execute the program.

### DESCRIPTION OF REFERENCE NUMERALS

100, 300, 500 . . . Encoding device
200, 400, 600 . . . Decoding device
101, 201 . . . Input part
103, 203 . . . Storage
105, 205 . . . Control part
106 . . . Framing part
206 . . . Frame combining part
107, 207 . . . Output part
110, 310, 1110 . . . Second-layer encoding part
5103 . . . Third-layer encoding part
510N . . . Nth-layer encoding part
111, 211 . . . Allocation part
113, 213, 313, 314, 413, 414, 1113 . . . Gain group set storage
115 . . . Difference calculating part
119, 1119 . . . Gain selecting part
21 . . . First-layer encoding part
23, 31 . . . First-layer decoding part
29 . . . Multiplexing part
39 . . . Demultiplexing part
210, 5302 . . . Second decoding part
5401 . . . First multiplier
230 . . . Multiplier
6302 . . . Second multiplier
630 (N−1) . . . (N−1)-th multiplier
6103 . . . Third-layer decoding part
610N . . . Nth-layer decoding part

What is claimed is:

1. A encoding device receiving an input signal and one of a decoded signal decoded from a first code obtained by encoding the input signal and a decoded signal obtained during generation of the first code, the encoding device comprising:
an allocation part allocating a gain group in a gain group set to each sample of the decoded signal by using a predetermined method, the gain group set including one or more gain groups, the gain groups including different numbers of values corresponding to gains; and
a gain selecting part outputting a gain code indicating a gain that results in the smallest difference between the input signal and the sample multiplied by the gain, among the gains in the allocated gain group, each of the gains in the gain group being identified by a value corresponding to the gain.

2. The encoding device according to claim 1, further comprising an input signal analyzing part analyzing a characteristic of the input signal, wherein:
the encoding device selects one of a plurality of gain group sets by using information representing the characteristic of the input signal, the plurality of gain group sets including different gain groups; and
the allocation part allocates a gain group included in the selected gain group set to each sample.

3. The encoding device according to claim 1 or 2, wherein the allocation part allocates a gain group including more values corresponding to gains than the other gain groups to a sample of the decoded signal that has a greater auditory impact than other samples.

4. the encoding device according to any one of claims 1 to 3, wherein:
the gain selecting part outputs a gain code i indicating a gain gmi that results in a minimum
dmi=−2gmi×xm×ym+gmi²×ym² or
a gain code i indicating a gain gmi that result in a maximum
dmi=2gmi×xm×ym−gmi²×ym²,
where i is an identification number associated with each gain, gmi represents each gain, ym represents each sample of the decoded signal, and xm represents each sample of the input signal.

5. The encoding device according to any one of claims 1 to 4, wherein the value corresponding to the gain is 2 gmi and gmi², where i is an identification number associated with each gain and gmi represents the gain.

6. A decoding device comprising:
a gain decoding part receiving a decoded signal obtained by decoding a first code by using a decoding scheme appropriate for the first code and a gain code and decoding the gain code to obtain a gain; and
a multiplier multiplying the decoded signal by the gain;
wherein the gain decoding part comprises an allocation part allocating a gain group in a gain group set to each sample of the decoded signal by using a predetermined method, the gain group set including one or more gain groups, the gain groups including different numbers of values corresponding to gains; and
the gain decoding part extracts and outputs a gain corresponding to the gain code from the allocated gain group.

7. The decoding device according to claim 6, wherein:
the gain decoding part further receives information representing a characteristic of the decoded signal and uses the information to select one of a plurality of gain group sets including different gain groups; and
the allocation part allocates a gain group included in the selected gain group set to each sample.

8. The decoding device according to claim 6 or 7, wherein the allocation part allocates a gain group including more values corresponding to gains than the other gain groups to a sample of the decoded signal that has a greater auditory impact than other samples.

9. A encoding method using an input signal and one of a decoded signal of a first code obtained by encoding the input signal and a decoded signal obtained during generation of the first code, the encoding method comprising:
an allocation step of allocating a gain group in a gain group set to each sample of the decoded signal by using a predetermined method, the gain group set including one or more gain groups, the gain groups including different numbers of values corresponding to gains; and
a gain selecting step of selecting a gain code indicating a gain that results in the smallest difference between the input signal and the sample multiplied by the gain, among the gains in the allocated gain group, each of the gains in the gain group being identified by a value corresponding to the gain.

10. The encoding method according to claim 9, further comprising an input signal analyzing step of analyzing a characteristic of the input signal, wherein:
one of a plurality of gain group sets is selected by using information representing the characteristic of the input signal, the plurality of gain group sets including different gain groups; and
the allocation step allocates a gain group included in the selected gain group set to each sample.

11. The encoding method according to claim 9 or 10, wherein the allocation step allocates a gain group including more values corresponding to gains than the other gain groups to a sample of the decoded signal that has a greater auditory impact than other samples.

12. The encoding method according to any one of claims 9 to 11, wherein:
the gain selecting step selects a gain code i indicating a gain gmi that results in a minimum
dmi=−2gmi×xm×ym+gmi²×ym² or
a gain code i indicating a gain gmi that result in a maximum
dmi=2gmi×xm×ym−gmi²×ym²,
where i is an identification number associated with each gain, gmi represents each gain, ym represents each sample of the decoded signal, and xm represents each sample of the input signal.

13. The encoding method according to any one of claims 9 to 12, wherein the value corresponding to the gain is 2 gmi and gmi², where i is an identification number associated with each gain and gmi represents the gain.

14. The encoding method according to any one of claims 9 to 13, further comprising:
a number N of nth-layer encoding steps, an (N−1) number of (n−1)-th-layer decoding steps, and an (N−2) number of (n−2)-th multiplying steps, where N is an integer greater than or equal to 3 and n=3, 4, . . . , N; wherein:
the (n−1)-th-layer decoding step uses a first-layer decoded signal and a second-layer code to obtain an (n−1)-th-layer decoded signal when n=3, and uses a value output from the (n−3)-th multiplying step and an (n−1)-th-layer code to obtain an (n−1)-th-layer decoded signal when n>3;
the (n−2) multiplying step multiplies the first-layer decoded signal or a value output from the (n−3)-th multiplying step by the (n−1)-th-layer decoded signal:
the nth-layer encoding step uses the input signal and an output value output from the (n−2)-th multiplying step to obtain an nth-layer code;
the (n−1)-th-layer decoding step comprises an allocation step of allocating a gain group to each sample of the first-layer decoded signal or each sample of an output value output from the (n−3)-th multiplying step, the allocation step allocating a gain group including more values corresponding to gains than the other gain groups to a sample of the decoded signal that has a greater auditory impact than other samples;
the (n−1)-th-layer decoding step extracts a gain corresponding to the (n−1)-layer code from the gain group and outputs the gain as an (n−1)-th-layer decoded signal; and
the nth-layer encoding step comprises:
an allocation step of allocating a gain group to each sample of a value output from the (n−2) multiplying step, the allocating step allocating a gain group including more values corresponding to gains than the other gain groups to a sample of the decoded signal that has a greater auditory impact than other samples;
a difference signal calculating step of multiplying each gain in the allocated gain group by the output value and subtracting the product from the input signal to obtain a difference signal; and
a gain selecting step of selecting a gain that yields a smallest difference signal for each output value from the gain group and outputting information about the selected gain as an nth-layer code.

15. A decoding method comprising:
a gain decoding step of using a decoded signal obtained by decoding a first code using a decoding scheme appropriate for the first code and a gain code to decode the gain code to obtain a gain; and
a multiplying step of multiplying the decoded signal by the gain;
wherein the gain decoding step comprises an allocation step of allocating a gain group in a gain group set to each sample of the decoded signal by using a predetermined method, the gain group set including one or more gain groups, the gain groups including different numbers of values corresponding to gains; and
the gain decoding step extracts a gain corresponding to the gain code from the allocated gain group.

16. The decoding method according to claim 15, wherein:
the gain decoding step uses information representing a characteristic of the decoded signal to select one of a plurality of gain group sets including different gain groups; and
the allocation step allocates a gain group included in the selected gain group set to each sample.

17. The decoding method according to claim 15 or 16, wherein the allocation step allocates a gain group including more values corresponding to gains than the other gain groups to a sample of the decoded signal that has a greater auditory impact than other samples.

18. The decoding method according to any one of claims 15 to 17, comprising a number N of nth-layer decoding steps and an (n−1) number of (n−1)-th multiplying steps, where N is an integer greater than or equal to 3 and n=3, 4, . . . , N; wherein,
the nth-layer decoding step comprises an allocation step of allocating a gain group to each sample of a value output from the (n−2)-th multiplying step, the allocating step allocating a gain group including more values corresponding to gains than the other gain groups to a sample of the decoded signal that has a greater auditory impact than other samples;
the nth-layer decoding step extracts a gain corresponding to an nth-layer code from the gain group and outputs the gain as an nth-layer decoded signal; and
the (n−1)-th multiplying step multiplies the value output from the (n−2) multiplying step by the nth-layer decoded signal.

19. A program for causing a computer to function as a encoding device or a decoding device according to any one of claims 1 to 8.
